(19) United States
(12) Patent Application Publication
(10) Pub. No.: US 2023/0047215 A1
(43) Pub. Date: Feb. 16, 2023

(54) THERMAL TREATMENT OF MINERAL RAW MATERIALS USING A MECHANICAL FLUIDISED BED REACTOR

(71) Applicants: thyssenkrupp Industrial Solutions AG, Essen (DE); thyssenkrupp AG, Essen (DE)

(72) Inventors: Andreas HOPPE, Lippstadt (DE); Meike DIETRICH, Drensteinfurt (DE); Jasmin HOLZER, Ennigerloh (DE); Juergen SCHNEBERGER, Ennigerloh (DE); Sven RUESCHHOFF, Beckum (DE); Rodrigo GOMEZ, Oelde (DE); Lukas BRACHT, Brilon (DE)

(73) Assignees: thyssenkrupp Industrial Solutions AG, Essen (DE); thyssenkrupp AG, Essen (DE)

(21) Appl. No.: 17/792,942

(22) PCT Filed: Jan. 11, 2021
(86) PCT No.: PCT/EP2021/050370

§ 371 Date: Jul. 14, 2022

(30) Foreign Application Priority Data
Jan. 20, 2020 (DE) 10 2020 200 602.4
Jan. 20, 2020 (LU) LU101613

(51) Int. Cl. C22B 26/12; F27B 7/18; C22B 1/243; C22B 1/24

(52) U.S. Cl. CPC C22B 26/12; F27B 7/18; C22B 1/243; C22B 1/2406; F27M 2003/03; F27D 15/02

(57) ABSTRACT

An apparatus for thermally treating lithium ores and other mineral raw material may include a comminution apparatus, a pelletization apparatus, and a thermal treatment apparatus. The pelletization apparatus can be a mechanical fluidized bed reactor. Further, a process for thermally treating lithium ore and other mineral raw material may involve comminuting the mineral raw material in a comminution apparatus to form a first product, pelletizing the first product in a mechanical fluidized bed reactor to form a second product, and thermally treating the second product in a thermal treatment apparatus. Ninety percent of all particles in the second product may have a particle size between 50 μm and 500 μm.

### CROSS REFERENCE TO RELATED APPLICATIONS

This application is a U.S. National Stage Entry of International Patent Application Serial Number PCT/EP2021/050370, filed Jan. 11, 2021, which claims priority to German Patent Application No. DE 10 2020 200 602.4, filed Jan. 20, 2020, and Luxembourg Patent Application No. LU 101613, filed Jan. 20, 2020, the entire contents of all of which are incorporated herein by reference.

### FIELD

The present disclosure generally relates to lithium ores, including processes and apparatuses for thermally treating mineral raw materials using mechanical fluidized bed reactors.

### BACKGROUND

U.S. Pat. No. 6,083,295 A discloses a process for processing of finely divided material comprising a pelletization.

WIPO Patent Publication No. WO 2017/144469 A1 discloses a process for thermal treatment of granular solids.

German Patent No. DE 27 26 138 A1 discloses a process and an apparatus for producing cement clinker from moist agglomerated cement raw material. The apparatus comprises a preheating zone, a deacidification zone and a sintering zone.

German Patent Application No. DE 10 2017 202 824 A1 discloses a plant for producing cement, in particular cement clinker, comprising a preheater having a plurality of cyclones, a calciner for deacidification and a rotary furnace.

European Patent No. EP 3 476 812 A1 discloses a method for drying of granulated material.

European Patent No. EP 0 500 561 B1 discloses an apparatus for mixing and thermal treatment of solids particles having a substantially horizontally arranged container. German Patent No. DE 1 051 250 discloses a process and an apparatus for mixing pulverulent or finely divided compositions with liquids. German Patent No. DE 27 29 477 C2 discloses a plowshare-like mixing means for such apparatuses. A similar mixing means for such apparatuses is also known from German Patent No. DE 197 06 364 C2. Corresponding mixing apparatuses are marketed from Gebrüder Lo\ddot{d}ige Maschinenbau GmbH as Ploughshare mixers and generate a mechanical fluidized bed in their interior.

Mixers from Lödige are known from Becker Markus: “It's all about the mix—The heavy-duty solution for mixing and granulation of sinter material in the steel industry”, Metal Powder Report, MPR Publishing Services, Shrewsbury, GB, vol. 75, no. 1, Jan. 1, 2020, pages 48-49, XP086082287, ISSN: 0026-0657, DOI: 10.1016/J.MPRP.2019.12.004.

Chinese Patent No. CN 108 179 264 A discloses the treatment of lithium mica, wherein lithium mica is dried by flash drying to obtain a dried product which is microground to obtain a lithium mica powder and mixed with sodium salt, calcium oxide and water.

U.S. Pat. No. 4,350,523 A discloses porous iron ore pellets.

Japanese Patent Publication No. JP H09 95742 A1 discloses the production of sintered ore through use of iron ore in water.

WIPO Patent Publication No. WO 96/22950 A1 discloses a process for utilizing dusts generated during the reduction of iron ore.

German Patent Application No. DE 10 2017 125707 A1 discloses a process and a plant for thermal treatment of a lithium ore.

Thus a need exists for a process that makes it possible to effect thermal treatment especially of ores that not only have an increased propensity for deposit formation but also can represent an increased risk of contamination of the air circuit as a result of their melting properties and/or particle sizes.

### BRIEF DESCRIPTION OF THE FIGURES

FIG. 1 is a schematic view of a first embodiment.

FIG. 2 is a schematic view of a second embodiment.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

One example process of the present disclosure may be performed, for example, in an apparatus for thermal treatment of mineral raw materials and is useful specifically for the thermal treatment of lithium ores, specifically of lithium aluminum silicate, for example spodumene (LiAl[Si₂O₈]) or petalite (LiAl[Si₄O₁₀]). The invention is particularly suitable for finely divided lithium ores comprising a high degree of contamination by sodium, potassium and/or iron components of >0.5% by weight (based on Na₂O, K₂O, Fe₂O₃). These impurities are predominantly in the form of one or usually more of the following minerals as concomitant minerals:

Muscovite (KAl₂AlSi₃O₁₀(OH)₂), typical admixture>2% by weight
Amphibol (KAl₂AlSi₃O₁₀(OH)₂), typical admixture>1% by weight
Plagioclase (Na,Ca)(Al,Si)₃O₈, typical admixture>4% by weight
Orthoclase KAlSi₃O₈, typical admixture>6% by weight

These minerals have their melting point at a temperature which is a lower or similar temperature to those at which the conversion of the lithium components takes place, for example the conversion of α-spodumene to β-spodumene. These admixtures cause the formation of extremely hard glassy agglomerates and deposits which markedly reduce the lithium yield, for example from above 90% to below 70%. These admixtures can moreover cause considerable limitations to process production output in conventional noninventive apparatuses.

The apparatus comprises a comminution apparatus, a pelletization apparatus and a thermal treatment apparatus. According to the invention the pelletization apparatus is a mechanical fluidized bed reactor.

It has been found that precisely a mechanical fluidized bed reactor results in a highly advantageous alteration of the finely ground mineral raw material. The relatively uniform size distribution of the agglomerated particles prevents both adhesion in a thermal treatment apparatus and conversion of the product into the gas phase. The latter has the result that the product must be filtered out of the offgas stream and thus practically recirculated, thus placing a burden on the overall process.

This reduces melt formation. The lithium yield can be increased to values of above 90% in the case of phyllosilicates such as zinnwaldite and to values of above 96% in the case of spodumene. Furthermore, the conversion rates of α-spodumene to β-spodumene increase to up to 100%.

While a normal fluidized bed reactor employs gases to mix a solid with the gas space and thus to fluidize and transport it, a mechanical fluidized bed reactor achieves this in purely mechanical fashion using a mixing means.

It has been found that the mechanical fluidized bed reactor has the effect that the very fine particles formed by grinding undergo agglomeration. This reduces dust formation in the subsequent process steps since especially particularly small particles can be very markedly reduced. This also results in substantially less adhesion of material to the walls of the preheater, especially when this is in the form of a plurality of cyclones arranged in series.

The preheater may be in the form of a cocurrent preheater. Therein, gas and solid are transported in the same direction while heat is transferred from the gas to the solid. Cyclones arranged in series are one example of a preheater. The heat transfer is effected in the connections between the cyclones in cocurrent; the cyclones then serve to separate gas and solid.

The preheater may also be in the form of a countercurrent preheater. A corresponding preheater is known for example and especially from German Patent No. DE 383 42 15 A1.

In a preferred embodiment of the invention finely divided lithium ores where all particles are smaller than 500 μm, preferably smaller than 350 μm, are employed.

In a preferred embodiment of the invention the lithium ore is selected from a group comprising:
Aluminum silicate, in particular spodumene, petalite
Lithium phosphate, in particular amblygonite LiAl[(F,OH)PO₄]
Lithium phyllosilicate, in particular zinnwaldite (KLiFe²⁺Al₂Si₃O₁₀(OH,F)₃
Lithium phyllosilicate, in particular lepidolite KLiAl₂Si₃O₁₀(OH,F)₃
Jadarite NaLi[B₃SiO₇(OH)]
Argillaceous minerals, in particular hectorite Na_{0.3}(Mg,Li)₃Si₄O₁₀(OH)₂
Eucryptite LiAlSi2O4
and mixtures thereof
and mixtures of these lithium ores with other also non-lithium-containing compounds,
wherein the mixture comprises a proportion of at least 70% by weight of these lithium ores.

By way of example the thermal treatment apparatus comprises a preheater, wherein the preheater comprises 2 to 8 cyclones. Cyclones allow fast and efficient heating of the material. The gas is simultaneously cooled in countercurrent, thus recovering the energy.

By way of example the thermal treatment apparatus comprises a calciner. The thermal treatment in a calciner is preferably limited to a residence time of 1 to 3 seconds in the calciner loop. In conventional plants the calciner is typically configured for a residence time of 60 s. This is made possible by the particularly good heat transfer in an apparatus according to the invention as a result of the small but uniform particle size especially in conjunction with possible influencing of the temperature profile via the loop through fuel and air stepping.

By way of example the calciner is a multilevel furnace.

By way of example a cooler is arranged downstream of the thermal treatment apparatus. For example and preferably the cooler consists of 2 to 8 cyclones. Cyclones allow fast and efficient cooling of the material. The gas is simultaneously heated in countercurrent. An indirect rapid cooling process may alternatively be employed to terminate the reaction in a controlled manner and without the use of oxygen.

By way of example the cooler is directly connected to the calciner. In this embodiment a furnace, in particular a rotary furnace, is thus completely eschewed. This markedly reduces the residence time in the overall apparatus and reduces energy consumption. However, this assumes rapid and uniform heating and thus chemical reaction which is ensured by the uniformizing effect of the mechanical fluidized bed. It was determined through the use of the mechanical fluidized bed reactor that an extremely uniform agglomeration of the starting material is achieved. This has the result that in addition to the exceptional adhesion-free passage through the preheater and the calciner an extremely good and especially uniform heating and thus reaction of the starting material is also achieved. It has thus been shown that the starting material has already been reacted after passage through the calciner. Prolonged heating in a furnace, which is necessary for complete conversion according to conventional wisdom, can therefore be eschewed. This results in savings both in the construction of a plant but especially also in operation.

By way of example the thermal treatment apparatus comprises a rotary furnace. This embodiment may be preferred when prolonged thermal treatment of the starting material results in optimized product properties.

By way of example a multilevel furnace is used for thermal treatment of the material instead of a rotary furnace. In this embodiment the arrangement of the burners over two or more levels makes it possible to establish a very precise temperature profile and thus avoid overheating which could result in melting of sensitive components.

Alternatively the apparatus may comprise both a rotary furnace and a multilevel furnace. This results in markedly longer residence times, for example in residence times of 30 min to 2 hours. One apparatus according to this embodiment is especially suitable for the thermal treatment of lithium phyllosilicates (zinnwaldite and lepidolite), in particular when these comprise additional additives, for example sulfate components and/or limestone. For conversion of such blends the solids/solids reactions require much greater residence times.

By way of example the mechanical fluidized bed reactor comprises a substantially horizontally arranged container. A shaft is arranged centrally along the longitudinal axis of the container, wherein mixing means are arranged radially on the shaft. These mixing means may in the simplest case be rod-like and arranged on the shaft vertically. It is particularly preferable when the mixing means have a plowshare-like configuration. Examples of plowshare-like mixing means may be found for example in German Patent No. DE 27 29 477 C2 or German Patent No. DE 197 06 364 C2. In the context of the invention substantially horizontal is to be understood as having the meaning in European Patent No. EP 0 500 561 B1.

By way of example the mechanical fluidized bed reactor comprises at least one fluid feed. It is also possible for further fluid feeds to be arranged, especially along the transport direction of the material. The fluid feed is particularly preferably used for the supply of water. Water promotes the agglomeration and thus results in more uniform particles. In particular, the addition of water reduces the proportion of the smallest particles, thus making it possible to particularly efficiently avoid dust formation and adhesion of material in the cyclones.

By way of example a fluid feed is arranged upstream of the mechanical fluidized bed reactor. This may be present alternatively or in addition to a fluid feed in the mechanical fluidized bed reactor.

By way of example the mechanical fluidized bed reactor comprises a fuel feed. Alternatively or in addition a fuel feed may also be carried out upstream of the mechanical fluidized bed reactor. This allows the fuel to be incorporated into the particles formed by agglomeration in the mechanical fluidized bed reactor. This fuel ignites in the subsequent process after exceeding its ignition temperature, for example in the calciner, and thus results in a substantially more targeted heating of the raw material.

By way of example a riser tube dryer is arranged between the mechanical fluidized bed reactor and the preheater. The riser tube dryer has two advantages. Firstly, especially water, which is used in the agglomeration in the mechanical fluidized bed reactor, can be discharged. Secondly, the material can be transported to the entry height of the preheater. The riser tube dryer may also be used for adjusting the particle size. By means of the gas velocity and optionally via a separation cyclone at the upper end of the riser tube dryer, especially excessively large particles may be separated and in particular recycled for re-grinding.

By way of example a homogenization stage is arranged between the comminution apparatus and the mechanical fluidized bed reactor. A homogenization stage is particularly advantageous when fuel and/or binder are added upstream of the homogenization stage.

By way of example a riser tube dryer is arranged between the mechanical fluidized bed reactor and the thermal treatment apparatus. The riser tube dryer has two advantages. Firstly, especially water, which is used in the agglomeration in the mechanical fluidized bed reactor, can be discharged. Secondly, the material can be transported to the entry height of the preheater.

The invention relates to a process for thermal treatment of mineral raw materials, in particular lithium ores, wherein the process comprises the steps of:
a) comminuting the mineral raw material in a comminution apparatus,
b) pelletizing the product from step a) in a pelletization apparatus,
c) thermal treatment of the product from step b) in a thermal treatment apparatus.

According to the invention the process has the feature that after step b) 90% of all particles have a particle size between 50 μm and 500 μm.

Advantageously the starting material may thus be very finely ground. It is typically necessary to strike a compromise. The more finely the materials are ground, the better and more homogeneous the combustion process. However, excessively small particles are disruptive to the process. Due to the upstream processing steps, however, for example and especially flotation, these upstream processing steps require small particle sizes to achieve sufficient enrichment. Yet these particles are disadvantageous for the thermal treatment since these small particle sizes result in large losses via filter dust. In addition, the abovementioned thermally sensitive components can undergo melt formation which in turn reduces the extractable lithium content and reduces or causes an outage in production output as a result of deposits. However, since the particles are not introduced into the process in the finely ground size this limitation is not applicable.

In a preferred embodiment of the invention finely divided lithium ores where all particles are smaller than 500 μm, preferably smaller than 350 μm, are employed in the process.

In a preferred embodiment of the invention the lithium ore is selected from a group comprising:
Aluminum silicate, in particular spodumene, petalite
Lithium phosphate, in particular amblygonite LiAl[(F,OH)PO₄]
Lithium phyllosilicate, in particular zinnwaldite (KLiFe²⁺ Al₂Si₃O₁₀(OH,F)₃
Lithium phyllosilicate, in particular lepidolite KLiAl₂Si₃O₁₀(OH,F)₃
Jadarite NaLi[B₃SiO₇(OH)]
Argillaceous minerals, in particular hectorite Na_{0.3}(Mg,Li)₃Si₄O₁₀(OH)₂
Eucryptite LiAlSi2O4
and mixtures thereof
and mixtures of these lithium ores with other also non-lithium-containing compounds, wherein the mixture comprises a proportion of at least 70% by weight of these lithium ores.

In a further embodiment the particles have a pellet strength of at least 5 N.

In a further embodiment of the invention a mechanical fluidized bed reactor is selected as the pelletization apparatus.

In a further embodiment of the invention a pelletizing disc is selected as the pelletization apparatus.

In a further embodiment of the invention a high pressure roller mill is selected as the pelletization apparatus.

In a further embodiment of the invention a briquetting press is selected as the pelletization apparatus.

In a further embodiment of the invention a fuel, in particular a fuel having an ignition temperature of 500° C. to 650° C., is added before and/or in step b). The fuel is preferably selected from the group comprising coal, coal dust, cellulose.

This fuel ignites in the subsequent process after exceeding its ignition temperature, for example in the calciner, and thus results in a substantially more targeted heating of the raw material.

In a further embodiment of the invention fuel is added up to a mass content of at most 50%, preferably of at most 20%.

In a further embodiment of the invention fuel is added up to a mass content of at least 0.1%, preferably of at least 5%.

In a further embodiment of the invention a binder is added before and/or in step b). For example and preferably the binder is selected from aluminum silicate or a sulfate. The binder is preferably added in a proportion of 3% by weight to 10% by weight. It is also possible to add further additives that promote the reaction.

According to the invention the thermal treatment in step c) is performed at a temperature of at least 950° C.

In a further embodiment of the invention the thermal treatment in step c) is performed at a temperature of at most 1200° C., preferably at most 1100° C., particularly preferably at most 1000° C.

In a further embodiment of the invention step c) is followed by a cooling of the product, wherein the product is preferably cooled below 600° C.

In a further embodiment of the invention step c) is followed by a comminution of the product.

In a further embodiment of the invention step a) comprises a wet grinding and step b) comprises a subsequent agglomeration without a preceding drying.

A further embodiment of the invention is performed such that the nitrogen content of the gas phase in the preheater is less than 30% by volume, preferably less than 15% by volume, particularly preferably less than 5% by volume. This is preferably achieved by supplying pure oxygen as secondary air in the burners. This has the advantage that a subsequent separation of the resulting carbon dioxide from the gas phase is facilitated. This is advantageously in combination with the agglomeration of the starting material since dusts are disruptive in the separation of the carbon dioxide. However, especially dusts are particularly markedly reduced by the process according to the invention. The separation of the carbon dioxide ensures that emission of greenhouse gases is avoided.

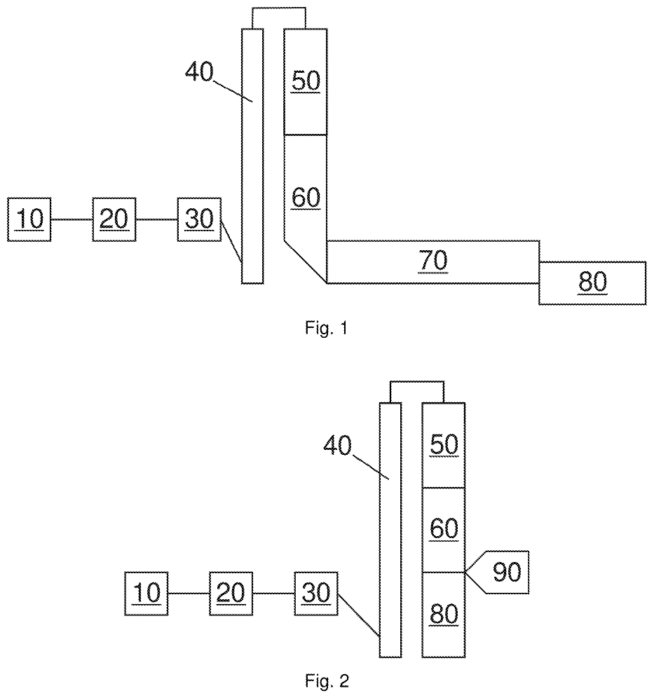

FIG. 1 shows a first embodiment of an apparatus for thermal treatment of mineral raw materials. The apparatus comprises a comminution apparatus 10, for example a mill. Arranged subsequently is a homogenization stage 20 in which the ground mineral raw material is mixed with a fuel and a binder. The starting material is subsequently pelletized in the pelletization apparatus 30, a mechanical fluidized bed reactor. The pelletized material is conveyed in a riser tube dryer 40 and transported into a preheater 50 which preferably consists of four to six cyclones. The preheater 50 has the calciner 60 arranged downstream of it and the calciner 60 has the rotary furnace 70 arranged downstream of it. The preheater 50, calciner 60 and rotary furnace 70 form the thermal treatment apparatus. The thermal treatment apparatus has the cooler 80 arranged downstream of it.

The second embodiment shown in FIG. 2 differs from the first embodiment in that the thermal treatment apparatus does not comprise a rotary furnace 70 but rather the cooler 80 connects directly to the calciner 60. To generate the heat the calciner 60 is connected to a burner 90. In this second embodiment the cooler 80 is preferably constructed from four to six cyclones.

### LIST OF REFERENCE NUMERALS

10 Comminution apparatus
20 Homogenization stage
30 Pelletization apparatus
40 Riser tube dryer
50 Preheater
60 Calciner
70 Rotary furnace
80 Cooler
90 Burner

1.-12. (canceled)

13. An apparatus for thermally treating lithium ore and other mineral raw material, the apparatus comprising:
a comminution apparatus;
a pelletization apparatus configured as a mechanical fluidized bed reactor; and
a thermal treatment apparatus.

14. The apparatus of claim 13 comprising a preheater that includes 2 to 8 cyclones.

15. The apparatus of claim 13 wherein the thermal treatment apparatus comprises a calciner.

16. The apparatus of claim 13 comprising a cooler disposed downstream of the thermal treatment apparatus.

17. The apparatus of claim 16 wherein the cooler is directly connected to the calciner.

18. The apparatus of claim 13 wherein the thermal treatment apparatus comprises a rotary furnace.

19. The apparatus of claim 13 wherein the mechanical fluidized bed reactor comprises a substantially horizontally arranged container, wherein a shaft is arranged centrally along a longitudinal axis of the container, wherein mixing means are arranged radially on the shaft.

20. The apparatus of claim 19 wherein the mixing means has a plowshare-like configuration.

21. The apparatus of claim 13 comprising a homogenization stage disposed between the comminution apparatus and the mechanical fluidized bed reactor.

22. The apparatus of claim 13 comprising a riser tube dryer disposed between the mechanical fluidized bed reactor and the thermal treatment apparatus.

23. A process for thermally treating lithium aluminum silicate and other mineral raw material, the process comprising:
comminuting the lithium aluminum silicate in a comminution apparatus to form a first product, wherein the lithium aluminum silicate has a high degree of contamination by sodium, potassium, and/or iron components of greater than 0.5% by weight based on Na₂O, K₂O, Fe₂O₃;
pelletizing the first product in a pelletization apparatus to form a second product, wherein the pelletization apparatus is a mechanical fluidized bed reactor, wherein 90% of all particles in the second product have a particle size between 50 μm and 500 μm; and
thermally treating the second product at a temperature of at least 950° C. in a thermal treatment apparatus.

24. The process of claim 23 comprising adding a fuel having an ignition temperature of 500° C. to 650° C. before or during the pelletizing.

25. The process of claim 24 wherein the fuel is coal, coal dust, or cellulose.

26. The process of claim 24 wherein the fuel is added up to a mass content of at most 50%.

27. The process of claim 24 wherein the fuel is added to a mass content of at least 0.1%.

28. The process of claim 23 comprising adding a binder before or during the pelletizing.

29. The process of claim 28 wherein the binder is aluminum silicate or a sulfate.

30. The process of claim 23 wherein thermally treating the second product occurs at a temperature of at most 1200° C.

31. The process of claim 23 comprising cooling the second product after the thermal treatment.

32. The process of claim 23 comprising comminuting the second product after the thermal treatment.

33. The process of claim 23 wherein the thermal treatment apparatus is a rotary furnace and a multilevel furnace, wherein the thermal treatment occurs with a residence time of 30 minutes to 2 hours.
